(19) United States
(12) Patent Application Publication
(10) Pub. No.: US 2005/0210430 A1
(43) Pub. Date: Sep. 22, 2005

(54) System and method to optimize logical configuration relationships in VLSI circuit analysis tools

(76) Inventors: S. Brandon Keller, Evans, CO (US); Gregory Dennis Rogers, Ft. Collins, CO (US); George Harold Robbert, Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/803,715

(22) Filed: Mar. 18, 2004

(51) Int. Cl. G06F 17/50

(52) U.S. Cl. 716/4; 716/2; 716/3

(57) ABSTRACT

A method for optimizing relationships between logic commands defining a circuit design is described. The method comprises, for each logic command determining whether the logic command is a primitive logic command; and, responsive to the logic command not being a primitive logic command, decomposing the logic command into its most primitive form.

### CROSS-REFERENCE TO RELATED APPLICATIONS

This application is related to the following commonly-owned, co-pending U.S. Patent Applications: U.S. patent application Ser. No. ______, filed ______ entitled “SYSTEM AND METHOD FOR FACILITATING EFFICIENT APPLICATION OF LOGICAL CONFIGURATION INFORMATION IN VLSI CIRCUIT ANALYSIS TOOLS” (Docket No. 200311736-1); U.S. patent application Ser. No. ______, filed ______ entitled “SYSTEM AND METHOD TO PRIORITIZE AND SELECTIVELY APPLY CONFIGURATION INFORMATION FOR VLSI CIRCUIT ANALYSIS TOOLS” (Docket No. 200311762-1); U.S. patent application Ser. No. ______, filed ______ entitled “SYSTEM AND METHOD FOR FLATTENING HIERARCHICAL DESIGNS IN VLSI CIRCUIT ANALYSIS TOOLS” (Docket No. 200311777-1); U.S. patent application Ser. No. ______, ______, filed entitled “SYSTEM AND METHOD FOR CONTROLLING ANALYSIS OF MULTIPLE INSTANTIATIONS OF CIRCUITS IN HIERARCHICAL VLSI CIRCUIT DESIGNS” (Docket No. 200311778-1); and U.S. patent application Ser. No. ______, filed ______ entitled “SYSTEM AND METHOD TO LIMIT RUNTIME OF VLSI CIRCUIT ANALYSIS TOOLS FOR COMPLEX ELECTRONIC CIRCUITS” (Docket No. 200311780-1); all of which are hereby incorporated by reference in their entirety.

### BACKGROUND

In the field of integrated circuit (“IC”) design and particularly very large scale integration (“VLSI”) design, it is desirable to test the design before implementation and to identify potential violations in the design. Before implementation on a chip, the information about a design, including information about specific signals and devices that comprise the design, as well as information about connections between the devices, are typically stored in a computer memory. Based on the connection and device information, the designer can perform tests on the design to identify potential problems. For example, one portion of the design that might be tested is the conducting material on the chip. In particular, representations of individual metal segments may be analyzed to determine whether they meet certain specifications, such as electromigration and self-heating specifications. Other tests that may be conducted include electrical rules checking tests, such as tests for noise immunity and maximum driven capacitance, and power analysis tests that estimate power driven by a particular signal and identify those over a given current draw. These tests may be performed using software tools referred to as VLSI circuit analysis tools.

Modern semiconductor IC chips include a dense array of narrow, thin-film metallic conductors, referred to as “interconnects”, that transport current between various devices on the IC chip. As the complexity of ICs continues to increase, the individual components must become increasingly reliable if the reliability of the overall IC is to be maintained. Due to continuing miniaturization of VLSI circuits, thin-film metallic conductors are subject to increasingly high current densities. Under such conditions, electromigration can lead to the electrical failure of interconnects in a relatively short period of time, thus reducing the lifetime of the IC to an unacceptable level. It is therefore of great technological importance to understand and control electromigration failure in thin film interconnects.

Electromigration can be defined as migration of atoms in a metal interconnect line due to momentum transfer from conduction electrons. The metal atoms migrate in the direction of current flow and can lead to failure of the metal line. Electromigration is dependent on the type of metal used and correlates to the melting temperature of the metal. In general, a higher melting temperature corresponds to higher electromigration resistance. Electromigration can occur due to diffusion in the bulk of the material, at the grain boundaries, or on the surface. For example, electromigration in aluminum occurs primarily at the grain boundary due to the higher grain boundary diffusivity over the bulk diffusivity and the excellent surface passivation effect of aluminum oxide that forms on the surface of aluminum when it is exposed to oxygen. In contrast, copper exhibits little electromigration in the bulk and at the grain boundary and instead primarily exhibits electromigration on the surface due to poor copper oxide passivation properties.

Electromigration can cause various types of failures in narrow interconnects, including void failures along the length of a line and diffusive displacements at the terminals of a line that destroy electrical contact. Both types of failure are affected by the microstructure of the line and can therefore be delayed or overcome by metallurgical changes that alter the microstructure. As previously noted, electromigration is the result of the transfer of momentum from electrons moving in an applied electric field to the ions comprising the lattice of the interconnect material. Specifically, when electrons are conducted through a metal, they interact with imperfections in the lattice and scatter. Thermal energy produces scattering by causing atoms to vibrate; the higher the temperature, the more out of place the atom is, the greater the scattering, and the greater the resistivity. Electromigration does not occur in semiconductors, but may in some semiconductor materials that are so heavily doped as to exhibit metallic conduction.

The driving forces behind electromigration are “direct force”, which is defined as the direct action of the external field on the charge of the migrating ion, and “wind force”, which is defined as the scattering of the conduction electrons by the metal atom under consideration. For simplicity, “electron wind force” often refers to the net effect of these two electrical forces. This simplification will also be used throughout the following discussion. These forces and the relation therebetween are illustrated in FIG. 1.

The electromigration failure process is predominantly influenced by the metallurgical-statistical properties of the interconnect, the thermal accelerating process, and the healing effects. The metallurgical-statistical properties of a conductor film refer to the microstructure parameters of the conductor material, including grain size distribution, the distribution of grain boundary misorientation angles, and the inclinations of grain boundaries with respect to electron flow. The variation of these microstructural parameters over a film causes a non-uniform distribution of atomic flow rate. Non-zero atomic flux divergence exists at the places where the number of atoms flowing into the area is not equal to the number of atoms flowing out of that area per unit time such that there exists either a mass depletion (divergence>0) or accumulation (divergence<0), leading to formation of voids and hillocks, respectively. In such situations, failure results either from voids growing over the entire line width, causing line breakage, or from extrusions that cause short circuits to neighboring lines.

The thermal accelerating process is the acceleration process of electromigration damage due to a local increase in temperature. A uniform temperature distribution along an interconnect is possible only absent electromigration damage. Once a void is initiated, it causes the current density to increase in the area around the void due to the reduction in the cross-sectional area of the conductor. The increase of the local current density is referred as “current crowding.” Since joule heating, or “self-heating”, is proportional to the square of current density, the current crowding effect leads to a local temperature rise around the void that in turn further accelerates the void growth. The whole process continues until the void is large enough to result in a line break.

Healing effects are the result of atomic flow in the direction opposite to the electron wind force, i.e., the “back-flow,” during or after electromigration. The back-flow of mass is initiated once a redistribution of mass has begun to form. Healing effects tend to reduce the failure rate during electromigration and partially heals the damage after current is removed. Nonhomogenities, such as temperature and/or concentration gradients, resulting from electromigration damage are the cause of the back-flow.

The effects of electromigration may be slow to develop; however, if an electromigration problem exists, the progress toward a fault is inexorable. The results of an electromigration problem are illustrated in FIGS. 2 and 3. Before current is applied to a section of an IC chip that is first powered up, the metal comprising the interconnects thereof is uniformly distributed, as illustrated in FIG. 2, which illustrates a side view of an interconnect 200. However, in a section of metal that is at risk for electromigration, the mass transport of metal, which occurs in the direction of average current, represented in FIG. 3 by an arrow 301, results in metal moving from a first end 302a of the section to a second end 302b thereof. At some future time, depending on the amount of current flowing through and the thickness of the interconnect 200, electromigration will result in the formation of a void 304 at the first end 302a and a hillock 304 at the second end 302b. Eventually, as previously described, this migration of metal from one end of the wire to the other will result in a failure of the interconnect 200.

As also previously noted, self-heating contributes to the electromigration and actually affects the surrounding wires as well. As a wire carries current, it will heat up, thereby lowering the limits for electromigration in surrounding wires as well as the wire under consideration. It is important, therefore, to consider the effects of both electromigration and self-heating (collectively “EM/SH”) when analyzing and verifying the reliability of an IC chip design.

Typically, circuit analysis tools (including, e.g., the EM/SH analysis tools) often require logic configuration to properly analyze the circuits in VLSI design. As VLSI designs continue to increase in complexity, it becomes critical that the logic configuration information relating to a circuit design be presented in an efficient manner.

### SUMMARY

One embodiment is a method for optimizing relationships between logic commands defining a circuit design. The method comprises, for each logic command determining whether the logic command is a primitive logic command; and, responsive to the logic command not being a primitive logic command, decomposing the logic command into its most primitive form.

### BRIEF DESCRIPTION OF THE DRAWINGS

FIG. 1 illustrates the driving forces behind electromigration, including direct force and wind force;

FIGS. 2 and 3 illustrate the effects of electromigration on an IC chip interconnect;

FIG. 4 is a flow diagram of a reliability verification tool (“RVT”) in one embodiment;

FIG. 5 is a schematic diagram illustrating the concept of nets in a VLSI circuit; and

FIG. 6 is a flowchart of one embodiment of a transitive closure process implemented by a circuit analysis tool, such as the RVT of FIG. 3.

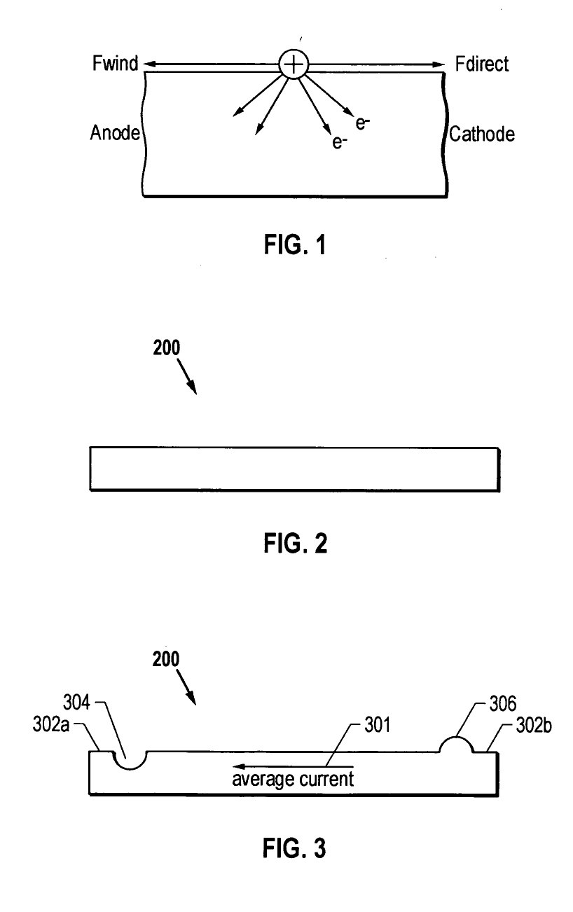

### DETAILED DESCRIPTION OF THE DRAWINGS

In the drawings, like or similar elements are designated with identical reference numerals throughout the several views thereof, and the various elements depicted are not necessarily drawn to scale.

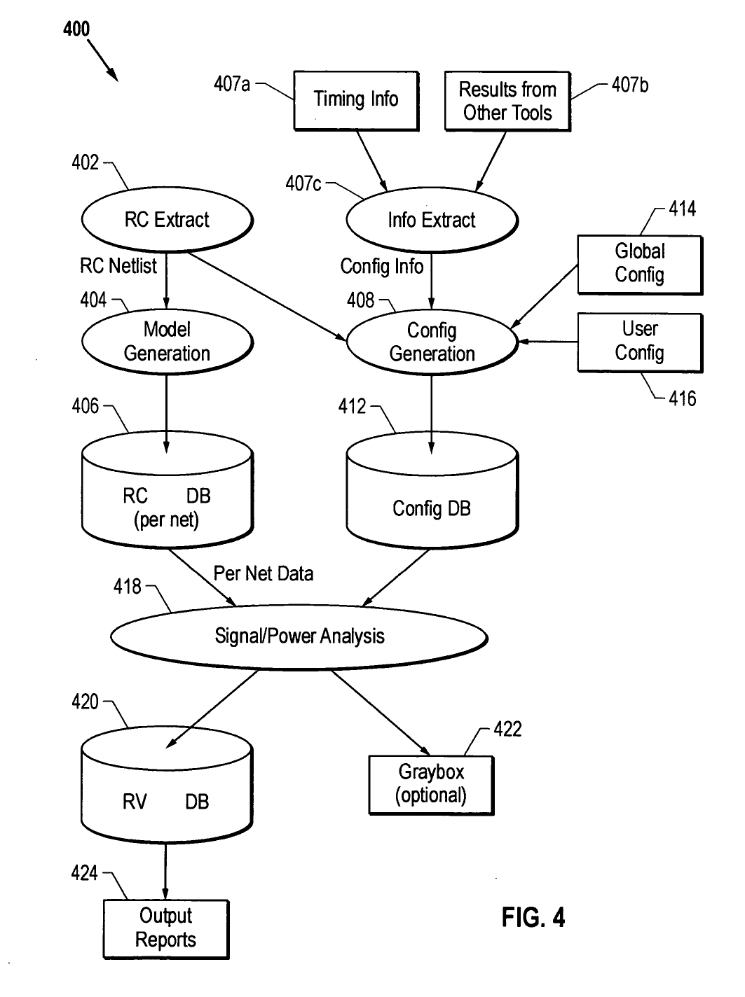

FIG. 4 is a flow diagram of one embodiment of a VLSI circuit analysis tool, specifically, a reliability verification tool (“RVT”) 400. In the illustrated embodiment, the RVT 400 is designed to find areas of an IC block layout that may have electromigration and/or self-heating (“EM/SH”) risks. The output files produced by the RVT 400 are useful for viewing violations in a text manner and a violations shapes representation can be loaded on top of the block artwork to provide a visual representation of the problem areas and the changes proposed by the RVT 400 to correct those problems.

Specifically, the RVT 400 is designed to assist designers with the challenging task of identifying potential EM/SH problem areas in their designs. Since the rules of electromigration are not always intuitive and problem areas can be hard to spot, the RVT 400 is an important tool for determining if the design has any violations that, if not discovered and corrected, could lead to future chip failure. This is due to the fact that faults that electromigration can produce develop slowly over time until the metal finally breaks.

In one embodiment, the RVT 400 provides a designer with a clear, easy-to-follow approach to identifying EM/SH violations. Theoretically, design rules should prevent most wires from risk of electromigration, but cases still exist in which there may be a problem. By running the RVT 400 on a design block, a designer can ensure that the wires in the block will be reliable in the long term and will not cause a chip failure. The RVT 400 accomplishes this by calculating the currents through each piece of metal and each contact array on the chip. It compares these currents with certain process rules describing the maximum current that a given width of metal or set of contacts may carry. Any currents that do not meet the limits are reported as violations.

In order to “calculate the currents”, as indicated above, the RVT 400 may be run in either “signal” or “power” mode to analyze metal connecting signals or to analyze the power grid. These two runs are performed separately to give better capacity and performance. In signal analysis, the RVT 400 first separates the chip into individual stages. A stage is a set of resistors that connect one or more driver FETs (i.e., those FETs that are connected to a supply) to the gates of one or more receiver FETs. These connections may pass through the channels of any number of pass FETs in the process. The RVT 400 takes each of these stages and attempts to simulate the likely combinations of on and off FETs, as dictated by logic configuration, taking the worst case currents determined over all of the simulations. The currents are then checked against the EM/SH rules.

In power analysis, the RVT 400 treats each power grid rail as its own stage. It uses the current through FETs connected to the rail determined in a previous signal analysis run to load the power grid. After simulating the grid with the load currents, it checks the currents calculated through each resistor against the EM/SH rules.

FIG. 4 illustrates the overall flow of data and control through the RVT 400. The diagram illustrated in FIG. 4 illustrates the flow that applies to both signal and power analysis. The RVT 400 relies on a special RC extract 402 to perform its analysis. In one embodiment, the RC extract 402 provides highly detailed resistance values to enable the EM/SH rules to be applied correctly.

A Model Generation module 404 processes the extracted RC information from the RC extract 402 into an RC database (“DB”) 406 for each block. This allows easy access of the information on a per-net basis so that only the nets for a particular stage, as opposed to the entire model, need to be loaded into memory. The RC DB 406 is reused from run to run of the RVT 400 and is only regenerated when a new extract is performed.

The RVT 400 also relies on configuration information, such as timing information 407a and results from other analysis tools 407b, extracted from other sources by an info extract module 407c. These sources produce configuration files that, once extracted, are read in by a configuration generation phase 408 of the RVT 400. As previously noted, the extracted configuration information input to the configuration generation phase 408 may include information extracted from circuit annotation, timing information and additional circuit properties from transistor-level static timing analysis tool runs, information extracted from circuit recognition, and node activity factor (“AF”) information.

In one embodiment, as indicated above, the RVT 400 has the ability to read some configuration information pertaining to logical relationships within the design, such as those logic configuration commands listed below. These commands may be specified via configuration files or via annotations directly associated with schematic representations of the design. Each of the block properties' values is a list of signal names, each of which may be prefixed by “!”, indicating the opposite logic sense should be applied to that signal. The block properties include:
set_high instructs the analysis tool to set the specified net(s) to logic 1
set_low instructs the analysis tool to set the specified net(s) to logic 0
unset instructs the analysis tool to that any previous set_high or set_low information should be removed from the specified net(s)
merge_nodes instructs the analysis tool to treat all of the specified nets as having the same logical value
mutex instructs the analysis tool that exactly one of the specified nets should have a value of 1
imutex instructs the analysis tool that no more than one of the specified nets should have a value of 1
ifthen instructs the analysis tool as to the logical relationship of nets based on the state of the first net
forbid forbids the specified combination of nets

In one embodiment, as also indicated above, the RVT 400 has two methods for determining the activity factor on nodes. Both of these may be overridden by user configuration information if desired. The first such method is to use the default activity factors according to the node's type as determined by circuit recognition and a transistor-level static timing analysis tool. The second is to read explicit activity factors for each node. This can either specify a user-created file for activity factors or it may run some other tool to generate activity factors. If this method is selected, any node that does not have an activity factor explicitly specified therefore will default to one based on node type.

Similar to the Model Generation module 404, the Configuration Generation module 408 consolidates all of the configuration information at the beginning of a run and places this in a Config DB 412 for easy per-net access. The Configuration Generation module 408 reads a global configuration file 414 specified by a tool administrator and a user configuration file 416 specified by a user on a per-block basis. Both of these configuration files 414, 416, may be used to override the extracted configuration if necessary.

In addition to combining all of the configuration information together in a per-net fashion, the Configuration Generation module 408 also propagates some logic configuration through a process referred to as “transitive closure”, as described in greater detail below.

A signal/power analysis module 418 performs the main work of the RVT 400. It handles one stage at a time, calculating the currents through each resistor and applying the EM/SH rules. It generates both a Reliability Verification database (“RV DB”) 420, which contains all of the information it calculates, and an optional “graybox” description 422 for the file. The RV DB 420 is subsequently processed to generate the various output reports that users actually read. In order to improve performance, the analysis may be run on serval machines in parallel. As each stage is independent, requiring only the information on the nets it contains, the analysis is easily parallelizable.

It should be noted that when the RVT 400 generates a graybox 422 for a given block, it will create both a netlist, or “BDL”, file and also a config file containing all configuration information for the ports of the graybox. This allows various configuration (such as node types or activity factors) to be propagated up from a graybox. The graybox information is read in by the Model Generation module 404 and the Configuration Generation module 410 when the graybox 422 is used in the analysis of a parent block.

The RVT 400 generates a variety of output reports 424 such as a text file containing a list of all resistors that failed the EM/SH rules, along with any stages that were discarded. The RVT 400 also generates layout shapes that highlight the violations at each level of the hierarchy. The violations shapes are all stored as blocks along with the rest of the output files 424.

Running a power analysis using the RVT 400 relies on the user to have previously run a signal analysis with the RVT at or above the level on which a power analysis is to be run. During the RVT signal analysis, the default is to write out the average case and worst case current through all driver FETs (i.e. any FETs with a source or drain of VDD or GND) to a “signal_rvdb” file so that power analysis can use those currents. This also includes writing currents through output drivers, which means that these stages are analyzed for currents, but no EM/SH checks are done on those stages and no resistor currents are reported for them.

The average and worst case currents are calculated in the signal run as follows. The worst case current is simply the worst case current through each driver FET seen during the signal run using the same activity factors (“AF”) and drive fights (“DF”) signal run. This current will be used in the worst case RVT power analysis, which is performed on the low level metal and via layers as specified in the global configuration file 414.

Calculating the average case current is a bit more complicated. The average case current is used to check EM/SH on the upper level metal and via layers as specified in the global configuration file 414, thus it is very important to get the current for the entire stage correct and not as important to get the current for each driver FET correct. Thus, for the average case power analysis, it is not advisable to use the worst case current. The global configuration file 414 may also specify different default activity factors for different node types to use with power analysis. For example, changing the default activity factor for static nodes to 0.2 instead of using the 0.5 used for worst case signal analysis, more accurately represents the power drawn.

During an RVT power analysis run, the RVT 400 collects the driver FET currents calculated during the RVT signal run, as described above, generates a power SPICE deck, simulates that deck, checks each resistor in the simulated grid against EM/SH rules, and generates output files, including violations files, and power grayboxes if requested to do so.

In electronics, components are viewed in terms of how they move signals back and forth across wires. All components have locations that attach to wires that make a connection to other locations on other components. Accordingly, an implicit requirement of VLSI design is that components are connected and connections carry information about the relationship of the connected components.

A related concept is that of a “net”, which is a single electrical path in a circuit that has the same value at all of its points. Any collection of wires that carries the same signal between components comprises a net. Moreover, if a component passes the signal though without altering it, such as is the case with a terminal, the net continues on subsequently connected wires. Otherwise, the net terminates a component that alters the signal and a new net begins on the other side of that component. A component that passes a signal unaltered is referred to as a passive component; a component that alters a signal that passes through is referred to as an active component.

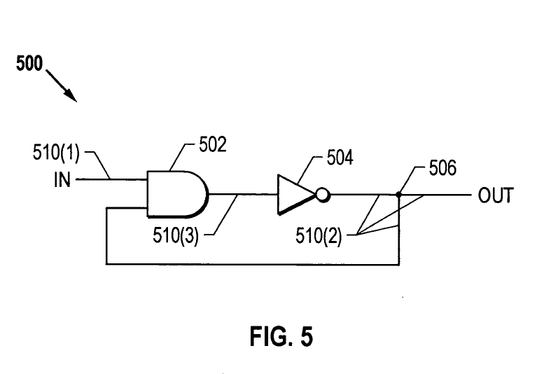

FIG. 5 further illustrates the concept of nets. As shown in FIG. 5, a circuit 500 comprises two active components, including an AND gate 502 and an inverter 504, and one passive component; i.e., a terminal 506. The circuit 500 also comprises three nets 510(1), 510(2), and 510(3). The first and second nets 510(1) and 510(2) are input and output nets, respectively. The third net 510(3) is an internal net that connects the output of the AND gate 502 to the input of the inverter 504.

Designers typically want to view an entire net to determine the path of a particular signal, which will identify the origin of the signal and the components that use the signal as input. Additionally, viewed abstractly, a circuit is merely a collection of gating components and the connections therebetween. A netlist omits the passive components and actual geometry of a circuit layout. Therefore, if a design tool is concerned only with the general functionality of a design, the collection of nets and active components supplies all of the information needed by the tool. It will be recognized that a net can also be identified by the name of a signal that traverses the net; therefore, where appropriate, the terms “net” and “signal” will be used interchangeably herein.

As previously noted, in one embodiment, there are several net logic commands that can be employed by a user to configure logical relationships between different nets, or signals. These commands are used to reduce the number of possible combinations of drivers that need to be simulated by eliminating those that cannot logically occur. Net logic commands commonly implemented by VLSI circuit analysis tools, such as the RVT 400, and their corresponding operations are set forth below again for convenience. It should be noted that the terms “net” and “signal” as used herein are interchangeable.
set_high instructs the analysis tool to set the specified net(s) to logic 1
set_low instructs the analysis tool to set the specified net(s) to logic 0
unset instructs the analysis tool to that any previous set_high or set_low information should be removed from the specified net(s)
merge_nodes instructs the analysis tool to treat all of the specified nets as having the same logical value
mutex instructs the analysis tool that exactly one of the specified nets should have a value of 1
imutex instructs the analysis tool that no more than one of the specified nets should have a value of 1
ifthen instructs the analysis tool as to the logical relationship of nets based on the state of the first net
forbid used to forbid the specified combination of nets

In each of the commands, a “!” preceding a net name is used to indicate the inverse of a net, such that !A is the inverse of A.

For example, the following command:
forbid A !B C D
   is used to forbid the specified combination of control nets. In particular, the immediately preceding example forbids the state A=1, B=0, C=1, D=1. The command:
ifthen !A B
   indicates that if net A is 0, then net B is 1. The command:
mutex A B C
   indicates that one and only one of nets A, B, and C must be equal to 1. In contrast, the command:
imutex A B C
   indicates that none or one of nets A, B, and C must be equal to 1. It will be recognized that the above-noted commands could be represented differently. For example, the command:
ifthen !A B
   could also be represented:
if0then1 A B.
   Similar alternative representations may be available for the remaining commands.

In accordance with one embodiment, to simplify storage and processing of logic configuration information, the commands are broken down, or decomposed, into more primitive logical relationships, as illustrated in Table I below.

TABLE I

| THE COMMAND | CAN BE REPRESENTED AS |
|---|---|
| mutex n1 n2 . . . nn | imutex n1 n2 . . . nn |
| | forbid !n1 !n2 . . . !nn |
| imutex n1 n2 . . . nn | ifthen n1 !n2 . . . !nn |
| | ifthen n2 !n1 !n3 . . . !nn |
| | . |
| | . |
| | . |
| merge_nodes n1 n2 . . . nn | ifthen n1 n2 . . . nn |
| | ifthen !n1 !n2 . . . !nn |
| | ifthen n2 n1 n3 . . . nn |
| | ifthen !n2 !n1 !n3 . . . !nn |
| forbid n1 n2 | ifthen n1 !n2 |
| | ifthen n2 !n1 |

It should be noted that the “forbid” case listed above is a special case for a two-net forbid. It will also be recognized that the representation of the mutex command set forth above includes an imutex command, which will be further broken down as illustrated above.

Once the commands are broken down into their primitive commands (basically comprising ifthen and forbid statements), the resulting logic configuration may be stored in the Config DB 412 (FIG. 4). Each ifthen command has two lists associated with it. The first is a list of all nets that are affected and the levels to which the listed nets should be set if the first net in the list of nets following the ifthen command is true (i.e., logic 1); this is referred to as the “if1list” of the net. The second is a similar list covering the case in which the first net in the list of nets following the ifthen command is false (i.e., logic 0); this is referred to as the “if0list” of the net. Each forbid is represented as a list of nets and their corresponding levels that are forbidden. Each net has a forbid list of which it is a member.

The decomposed logic commands can be further simplified by closing inference loops through a process referred to as “transitive closure”, which is described in detail below with reference to the following example.

In particular, given the following:
ifthen !n1 !n2
ifthen !n2 !n3
   one can infer the relationship:
ifthen !n1 !n3

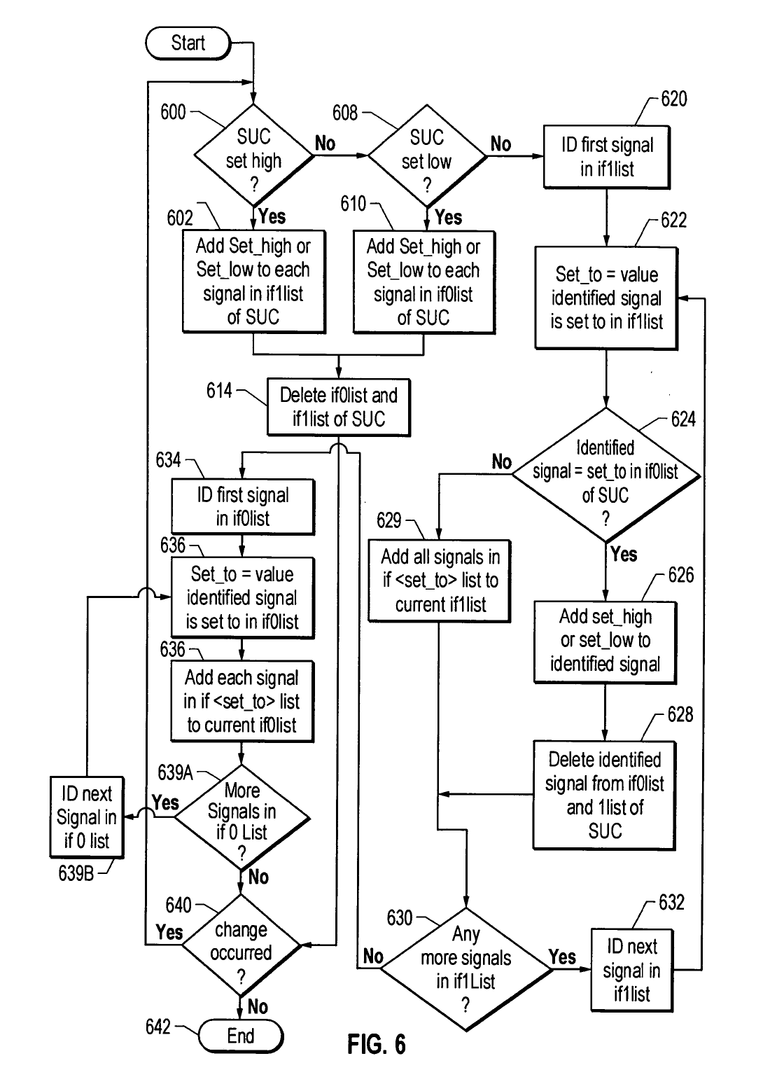

FIG. 6 illustrates a flowchart of one embodiment of the transitive closure process. It will be recognized that the process illustrated in FIG. 6 is performed for each net, or signal, in a design. In step 600, a determination is made whether a signal under consideration (“SUC”) is set high. If so, execution proceeds to step 602, in which each signal in the if1list of the SUC has an appropriate set_high (if the signal is to be set high when the SUC is set high) or set_low (if the signal is to be set low when the SUC is set high) added thereto. It will be recognized that the result of step 602 is that each signal listed in the if1list of the SUC will be set to the value indicated therein. If in step 600 it is determined that the SUC is not set high, then execution proceeds to step 608. In step 608, a determination is made whether the SUC is set low. If so, execution proceeds to step 610, in which each signal in the if0list of the SUC has an appropriate set_high (if the signal is to be set high when the SUC is set low) or set_low (if the signal is to be set low when the SUC is set low) added thereto. It will be recognized that the result of step 612 is that each signal listed in the if0list of the SUC will be set to the value indicated therein. Following execution of step 602 or 612, execution proceeds to step 614, in which the if0list and the if1list of the SUC are deleted.

If in step 608 it is determined that the SUC is not set low, meaning that the logic level of the SUC has not been determined, execution proceeds to step 620. In step 620, a first signal in the if1list of the SUC is identified and execution proceeds to step 622. In step 622, a variable “set_to” is set to the value of the identified signal in the if1list of the SUC. In step 624, a determination is made whether the identified signal is equal to the value of set_to in the if0list of the SUC as well. If so, execution proceeds to step 626, in which a set_high (if the value of set_to is 1) or set_low (if the value of set_to is 0) is added to the identified signal, and then to step 628, in which the identified signal is deleted from both the if1list and the if0list of the SUC. It will be recognized that the result of step 626 is that the identified signal listed in the if1list of the SUC will be set to the value indicated therein.

If a negative determination is made in step 624, execution proceeds to step 629, in which the contents of the if<set_to>list (i.e., the if1list if the value of <set_to> is equal to 1 and the if0list if the value of <set_to> is equal to 0) of the identified signal are added to the if1list of the SUC.

In step 630, a determination is made whether there are any more signals in the if1list of the SUC. If so, execution proceeds to step 632, in which a next signal in the if1list of the SUC is identified, and then returns to step 620. If in step 632 it is determined that the if1list of the SUC is empty, execution proceeds to step 634. In step 634, a first signal in the if0list of the SUC is identified. In step 636, the set_to variable is set to the value of the identified signal in the if0list. In step 638, the contents of the if<set_to>list of the identified signal are added to the if0list of the SUC.

In step 639A, a determination is made whether there are more signals in the if0list. If so, execution proceeds to step 639B, in which the next signal in the if Olist is identified, and then returns to step 636. Responsive to a negative determination in step 639A, execution proceeds to step 640. Similarly, following the execution of step 614, execution proceeds to step 640. In step 640, a determination is made whether a change has occurred, e.g., by the addition to the if0list or if1list of one or more signals that did not already exist in that list or the deletion of a nonempty if0list or if1list. If so, execution returns to step 600; otherwise, execution terminates in step 642.

An algorithm for implementing the process illustrated in FIG. 6 is set forth below.

```
do
    for each signal
        if (this signal is set high)
            for each signal in if1list
                add  a  set_high  (or  set_low)  to
                signal  depending  on  how  this  is
                specified to be set
            delete the if1list and if0list
        else if (this signal is set low)
            for each signal in if0list
                add  a  set_high  (or  set_low)  to
                signal  depending  on +111 how  this  is
                specified to be set
            delete the if1list and if0list
        else
            for each signal in if1list
                set_to=level it's set to
                if  (signal=<set_to>)  is  also  in
                if0list
                    add a set_high (or set_low) to
                    signal depending on how this
                    is specified to be set
                else
                    for  each  signal  in
                    if<set_to>list
                        add  that  signal  and
                        level  to  the  current
                        if1list
                for each signal in if0list
                    set_to=level it's set to
                    for  each  signal  in
                    if<set_to>list
                        add  that  signal  and
                        level  to  the  current
                        if0list
while (something changed);
```

It should be noted that “something changed” is only set when one of the “adds” above adds something that does not already exist in the given list or when a non-empty list is deleted.

By representing each command in more primitive form, as described herein, processing code for processing the internal representation of the commands can be simplified. Examples of this processing code include setting control signals according to what else has been set and the logic configuration given, determining that a given combination of control signals is disallowed by the given logic configuration, and propagating logic configuration ahead of time so that all logic dependencies are directly represented. In this manner, the challenges inherent in storing and applying large amounts of configuration information within a VLSI circuit analysis tool are alleviated.

Moreover, the transitive closure process provides a significant decrease in the amount of time needed to evaluate logical consequences of setting a particular signal to a given logic value, since all relationships are directly represented. The embodiments also enable the logical relationships between signals to be propagated outside of particular circuits, which can be important for analysis tools that do not hold the entire design in memory at a single time, such that relationships between nodes may not be readily determinable without the teachings of the embodiments herein.

An implementation of the invention described herein thus provides system and method to optimize logical configuration relationships in VLSI circuit analysis tools. The embodiments shown and described have been characterized as being illustrative only; it should therefore be readily understood that various changes and modifications could be made therein without departing from the scope of the present invention as set forth in the following claims.

1. A method for optimizing relationships between logic commands defining a circuit design, the method comprising, for each logic command:
determining whether the logic command is a primitive logic command; and
responsive to the logic command not being a primitive logic command, decomposing the logic command into its most primitive form.

2. The method of claim 1 wherein the decomposing comprises representing the logic command as a combination of primitive logic commands.

3. The method of claim 2 wherein the combination of primitive logic commands is logically equivalent to the logic command.

4. The method of claim 2 further comprising replacing the logic command with the combination of primitive logic commands.

5. The method of claim 1 wherein each primitive logic command comprising a first type of primitive logic command has associated therewith an if1list comprising a list of nets and a corresponding logic level to which each of those nets are to be set if a first net of a list of nets following the first type of primitive logic command is set to logic one, and further wherein each primitive logic command comprising a first type of primitive logic command has associated therewith an if0list comprising a list of nets and a corresponding logic level to which each of those nets are to be set if a first net of a list of nets following the first type of primitive logic command is set to logic zero.

6. The method of claim 1 wherein each primitive logic command comprising a second type of logic command has associated therewith a forbid list comprising a list of nets and corresponding levels thereof that are not permitted to occur.

7. The method of claim 1 wherein each logic command is followed by a list of one or more nets to which the logic command is to be applied.

8. The method of claim 1 wherein the logic command is selected from the group of logic commands consisting of ifthen, forbid, mutex, imutex, and merge_nodes commands.

9. The method of claim 1 wherein each primitive logic command of the combination of more primitive logic commands is selected from a group of logic commands consisting of ifthen and forbid commands.

10. The method of claim 5 further comprising, for each net listed in the if1list of a net that is set by logic configuration to a logic level of one:
setting a logic level of the listed net to its corresponding logic level; and
subsequent to the setting, deleting the if1list and if0list of the net that is set to a logic level of one.

11. The method of claim 5 further comprising, for each net listed in the if0list of a net that is set by logic configuration to a logic level of zero:
setting a logic level of the listed net to its corresponding logic level; and
subsequent to the setting, deleting the if1list and if0list of the net that is set to a logic level of zero.

12. The method of claim 5 further comprising, for each net listed in the if1list of a net the logic level of which has not been established:
if a logic level of the listed net is set to zero in if1list of the net the logic level of which has not been established, adding contents of an if0list of the listed net to the if1list of net the logic level of which has not been established; and
if a logic level of the listed net is set to one in if1list of the net the logic level of which has not been established, adding contents of an if1list of the listed net to the if1list of net the logic level of which has not been established.

13. The method of claim 5 further comprising, for each net listed in the if0list of a net the logic level of which has not been established:
if a logic level of the listed net is set to zero in if0list of the net the logic level of which has not been established, adding contents of an if0list of the listed net to the if0list of net the logic level of which has not been established; and
if a logic level of the listed net is set to one in if0list of the net the logic level of which has not been established, adding contents of an if1list of the listed net to the if0list of net the logic level of which has not been established.

14. An analysis tool for optimizing relationships between logic commands defining a circuit design, the tool comprising:
means for determining whether a logic command is a primitive logic command; and
means responsive to the logic command not being a primitive logic command for decomposing the logic command into its most primitive form.

15. The tool of claim 14 wherein the means for decomposing comprises means for representing the logic command as a combination of primitive logic commands.

16. The tool of claim 15 wherein the combination of primitive logic commands is logically equivalent to the logic command.

17. The tool of claim 15 further comprising means for replacing the logic command with the combination of primitive logic commands.

18. The tool of claim 14 wherein each primitive logic command comprising a first type of primitive logic command has associated therewith an if1list comprising a list of nets and a corresponding logic level to which each of those nets are to be set if a first net of a list of nets following the first type of primitive logic command is set to logic one, and further wherein each primitive logic command comprising a first type of primitive logic command has associated therewith an if0list comprising a list of nets and a corresponding logic level to which each of those nets are to be set if a first net of a list of nets following the first type of primitive logic command is set to logic zero.

19. The tool of claim 14 wherein each primitive logic command comprising a second type of logic command has associated therewith a forbid list comprising a list of nets and corresponding levels thereof that are not permitted to occur.

20. The tool of claim 14 wherein each logic command is followed by a list of one or more nets to which the logic command is to be applied.

21. The tool of claim 14 wherein the logic command is selected from the group of logic commands consisting of ifthen, forbid, mutex, imutex, and merge_nodes commands.

22. The tool of claim 14 wherein each primitive logic command of the combination of more primitive logic commands is selected from a group of logic commands consisting of ifthen and forbid commands.

23. The tool of claim 18 further comprising, for each net listed in the if1list of a net that is set to a logic level of one:
means for setting a logic level of the listed net to its corresponding logic level; and
means for deleting the if1list and if0list of the net that is set to a logic level of one subsequent to the setting.

24. The tool of claim 18 further comprising, for each net listed in the if0list of a net that is set to a logic level of zero:
means for setting a logic level of the listed net to its corresponding logic level; and
means for deleting the if1list and if0list of the net that is set to a logic level of zero subsequent to the setting.

25. The tool of claim 18 further comprising, for each net listed in the if1list of a net the logic level of which has not been established:
means responsive to a case in which a logic level of the listed net is set to zero in if1list of the net the logic level of which has not been established for adding contents of an if0list of the listed net to the if1list of net the logic level of which has not been established; and
means responsive to a case in which a logic level of the listed net is set to one in if1list of the net the logic level of which has not been established for adding contents of an if1list of the listed net to the if1list of net the logic level of which has not been established.

26. The tool of claim 18 further comprising, for each net listed in the if0list of a net the logic level of which has not been established:
means responsive to a case in which a logic level of the listed net is set to zero in if0list of the net the logic level of which has not been established for adding contents of an if0list of the listed net to the if0list of net the logic level of which has not been established; and
means responsive to a case in which a logic level of the listed net is set to one in if0list of the net the logic level of which has not been established for adding contents of an if1list of the listed net to the if0list of net the logic level of which has not been established.

27. A computer-readable medium operable with a computer for optimizing relationships between logic commands defining a circuit design, the medium having stored thereon:
computer-executable instructions for determining whether a logic command is a primitive logic command; and
computer-executable instructions responsive to the logic command not being a primitive logic command for decomposing the logic command into its most primitive form.

28. The computer-readable medium of claim 27 wherein the computer-executable instructions for decomposing comprises computer-executable instructions for representing the logic command as a combination of primitive logic commands.

29. The computer-readable medium of claim 28 wherein the combination of primitive logic commands is logically equivalent to the logic command.

30. The computer-readable medium of claim 28 further having stored thereon computer-executable instructions for replacing the logic command with the combination of primitive logic commands.

31. The computer-readable medium of claim 27 wherein each primitive logic command comprising a first type of primitive logic command has associated therewith an if1list comprising a list of nets and a corresponding logic level to which each of those nets are to be set if a first net of a list of nets following the first type of primitive logic command is set to logic one, and further wherein each primitive logic command comprising a first type of primitive logic command has associated therewith an if0list comprising a list of nets and a corresponding logic level to which each of those nets are to be set if a first net of a list of nets following the first type of primitive logic command is set to logic zero.

32. The computer-readable medium of claim 27 wherein each primitive logic command comprising a second type of logic command has associated therewith a forbid list comprising a list of nets and corresponding levels thereof that are not permitted to occur.

33. The computer-readable medium of claim 27 wherein each logic command is followed by a list of one or more nets to which the logic command is to be applied.

34. The computer-readable medium of claim 27 wherein the logic command is selected from the group of logic commands consisting of ifthen, forbid, mutex, imutex, and merge_nodes commands.

35. The computer-readable medium of claim 27 wherein each primitive logic command of the combination of more primitive logic commands is selected from a group of logic commands consisting of ifthen and forbid commands.

36. The computer-readable medium of claim 31 further having stored thereon, for each net listed in the if1list of a net that is set to a logic level of one:
computer-executable instructions for setting a logic level of the listed net to its corresponding logic level; and
computer-executable instructions for deleting the if1list and if0list of the net that is set to a logic level of one subsequent to the setting.

37. The computer-readable medium of claim 31 further having stored thereon, for each net listed in the if0list of a net that is set to a logic level of zero:
computer-executable instructions for setting a logic level of the listed net to its corresponding logic level; and
computer-executable instructions for deleting the if1list and if0list of the net that is set to a logic level of zero subsequent to the setting.

38. The computer-readable medium of claim 31 further having stored thereon, for each net listed in the if1list of a net the logic level of which has not been established:
computer-executable instructions responsive to a case in which a logic level of the listed net is set to zero in if1list of the net the logic level of which has not been established for adding contents of an if0list of the listed net to the if1list of net the logic level of which has not been established; and
computer-executable instructions responsive to a case in which a logic level of the listed net is set to one in if1list of the net the logic level of which has not been established for adding contents of an if1list of the listed net to the if1list of net the logic level of which has not been established.

39. The computer-readable medium of claim 31 further having stored thereon, for each net listed in the if Olist of a net the logic level of which has not been established:
computer-executable instructions responsive to a case in which a logic level of the listed net is set to zero in if0list of the net the logic level of which has not been established for adding contents of an if0list of the listed net to the if0list of net the logic level of which has not been established; and
computer-executable instructions responsive to a case in which a logic level of the listed net is set to one in if0list of the net the logic level of which has not been established for adding contents of an if1list of the listed net to the if0list of net the logic level of which has not been established.
